(19) United States
(12) Patent Application Publication
(10) Pub. No.: US 2008/0014545 A1
(43) Pub. Date: Jan. 17, 2008

(54) Apical irrigation fluid delivery apparatus

(76) Inventor: Doug Schippers, West Olive, MI (US)

Correspondence Address: THE WATSON INTELLECTUAL PROPERTY GROUP, PLC, 3133 HIGHLAND DRIVE, SUITE 200, HUDSONVILLE, MI, 49426, US

(21) Appl. No.: 11/807,665

(22) Filed: May 30, 2007

Related U.S. Application Data
(60) Provisional application No. 60/809,654, filed on May 31, 2006.

(51) Int. Cl. A61C 17/02

(52) U.S. Cl. 433/27; 433/32; 433/81

(57) ABSTRACT

An apical irrigation fluid delivery apparatus comprising an applicator, a vacuum supply assembly and an irrigation fluid supply assembly. The applicator assembly includes a body with a vacuum applicator assembly and a tooth fluid directing assembly. The applicator is configured to irrigate a canal of a tooth through negative pressure by disposing an elongated vacuum tube within the canal, wherein the elongated vacuum tube can draw fluid from the fluid directing assembly through the canal. The applicator assembly includes both the fluid directing assembly and the vacuum supply assembly so as to allow for single handed irrigation of the canal of the root.

### CROSS-REFERENCE TO RELATED APPLICATION

This application claims priority from U.S. Provisional Patent Application Ser. No. 60/809,654 filed May 31, 2006, entitled “Apical Irrigant Delivery Apparatus,” the entire specification of which is hereby incorporated by reference.

### BACKGROUND OF THE DISCLOSURE

1. Field of the Disclosure

The present disclosure relates in general to dental devices, and in particular, to an apical irrigation fluid delivery apparatus which utilizes negative pressure to clean and irrigate a root canal during a dental procedure.

2. Background Art

One common and often dreaded dental procedure is commonly referred to as a root canal procedure. Human teeth typically have one to four canals that connect the pulp chamber to the tip of the tooth. Blood vessels and nerves are positioned within these canals. Cracks or cavities in the enamel of a tooth can cause breaches which lead to the pulp chamber. If such a breach occurs, future infection of the pulp chamber and loss of tooth is virtually inevitable.

In such situations, it is common to perform a procedure referred to as a root canal procedure to stop infection and to save the tooth (known as a pulpectomy). The procedure consists of drilling into the tooth, and in particular into the pulp chamber of the tooth. Next, the dentist removes the pulp and cleans out the canals. Once the canals have been cleaned, the tooth is filled with an inert material. In some instances, it may be necessary to reconstruct a tooth after the root and pulp chamber have been filled. This procedure is sometimes referred to as a crown.

Problematically, if the pulp chamber and the canals are not fully cleaned of the infection, a subsequent infection can result which can lead to loss of the tooth. To insure that the canals are fully cleaned, irrigation systems have been developed. These irrigation systems provide fluids (including, but not limited to sodium hypochlorite, chlorhexidine gluconate (optionally with cetrimide, commonly referred to as Cetrexidin), ETDA (Ethylene-diaminetetraacetic acid and framycetin sulfate (Septomixine). The fluids perform different cleaning, disinfecting and preparation functions.

To clean the entire root canal, it is desirable to deliver the irrigation fluid to the apical region, with the desire of reaching the apical termination, which is at the end of the root canal. Certain devices have been developed to provide irrigation fluid to the root canal. Some of the devices include an elongated tube of narrow diameter which can be placed deep into the root canal. The irrigation fluid is then directed from the distal end of the elongated tube and driven toward the apical termination. A vacuum source can be supplied at the surface of the tooth to suck the irrigation fluid out of the mouth of the patient.

There are certain problems associated with such a canal irrigation device. Specifically, as the fluid is directed to the apical termination, the apical termination is exposed to the forces of the fluid drive out of the elongated tube. In many instances, the fluid can damage the apical termination. Second, the fluid flow may result in areas of stagnation, which, in turn, preclude the required flow across various regions of the canal.

Other devices have been developed which facilitate the suction or negative pressure proximate the apical region and the apical termination. While such a solution advances over the prior positive pressure system, in terms of performance. These prior art solutions have likewise suffered from shortcomings. In particular, one such device, comprises a device which requires multiple people to operate. Furthermore, such a device requires careful placement and operation of multiple components in an complicated configuration.

Accordingly, it is an object of the invention to provide an irrigation system which can deliver an irrigation fluid to the apical region during a root canal procedure.

This object as well as other objects of the present invention will become apparent in light of the present specification, claims, and drawings.

### SUMMARY OF THE DISCLOSURE

The disclosure is directed to an apical irrigation fluid delivery apparatus. The apparatus comprises an applicator assembly, a vacuum supply assembly and an irrigation fluid supply assembly. The applicator assembly includes a body, a vacuum applicator assembly and a tooth directing assembly. The body includes an outer surface, a proximal end and a distal end opposite the proximal end. The vacuum applicator assembly includes a vacuum conduit and an apical vacuum assembly. The apical vacuum assembly comprises an elongated vacuum tube in fluid communication with the vacuum conduit and a distal end having an inlet region. The distal end is spaced apart from the distal end of the body. The elongated vacuum tube is structurally configured for insertion into an apical region of a canal of a patient. The tooth fluid directing assembly comprises a fluid supply conduit and a dispensing opening. The dispensing opening extends away from the applicator assembly proximate the apical vacuum assembly and terminates prior to the distal end of the elongated vacuum tube.

The vacuum supply assembly includes a vacuum source in communication with the vacuum conduit of the vacuum applicator assembly and a vacuum actuator coupled to the vacuum source which selectively places the vacuum source in communication with the elongated vacuum tube. The irrigation fluid supply assembly includes a reservoir and a fluid flow rate controller including a pump. The pump is coupled to the reservoir and to the fluid supply conduit. A fluid flow actuator is coupled to the fluid flow rate controller which selectively directs fluid from the reservoir to the fluid supply conduit.

In a preferred embodiment, the apparatus further comprises an overflow vacuum inlet extending away from the distal end of the body such that the dispensing opening of the tooth directing assembly is positioned between the overflow vacuum inlet and the distal end of the elongated vacuum tube of the apical vacuum assembly.

In one such embodiment, the overflow vacuum inlet includes a cross-sectional area which is larger than a cross-sectional area of the inlet region of the elongated vacuum tube and larger than a cross-sectional area of the dispensing opening of the tooth fluid directing assembly.

In another preferred embodiment, the apparatus further comprises a neck region proximate the distal end, the neck region angled relative to the body at an angle of approximately 20° and 50°.

In yet another preferred embodiment, the applicator assembly is configured for handling with a single hand of a dentist.

In another preferred embodiment, the distal end of the elongated vacuum tube terminates at a termination end. The inlet region further comprises a plurality of openings spaced away from the termination end.

In another preferred embodiment, the plurality of openings comprises a plurality of rows of openings each sequentially spaced apart from the termination end of the distal end of the elongated vacuum tube.

In a preferred embodiment, the irrigation fluid supply conduit further comprises a heater assembly including a heater element associated with one of the fluid flow rate controller and the fluid supply conduit. Additionally, a heater control member is coupled to the heater assembly for controlling the intensity of the heater element.

In one such embodiment, the heater assembly further includes a heater temperature display associated with the heater control member. The heater control member additionally includes at least one button for altering the intensity of the heater element.

In another embodiment, the apparatus further includes a plurality of fluid reservoirs and a reservoir selector for selecting the desired reservoir for placement in fluid communication with the fluid supply conduit of the fluid directing assembly.

In yet another embodiment, the fluid flow rate controller further includes a flow rate control member having a range of adjustable flow rates and a flow rate display. The flow rate display is configured to display a current flow rate within the range of adjustable flow rates.

In another embodiment, the irrigation fluid supply assembly and the vacuum supply assembly are positioned within a housing. The housing includes a control panel, an applicator hook and a reservoir storage region.

In another embodiment, the control panel further includes the vacuum selector, a fluid flow rate controller and a fluid temperature selector.

Preferably, in such an embodiment, the reservoir storage region includes a plurality of reservoirs positioned thereon.

In another preferred embodiment, the vacuum conduit includes a constant radius region along a portion of the length thereof extending to the distal end. The vacuum conduit is configured for severing to a desired length.

### BRIEF DESCRIPTION OF THE DRAWINGS

The invention will now be described with reference to the drawings wherein:

FIG. 1 of the drawings is a perspective view of the apparatus of the present invention;

FIG. 2 of the drawings is a cross-sectional elevational view of the hand piece of the present invention;

FIG. 3 of the drawings is a partial perspective cross-sectional view of the end of the hand piece of the present invention;

FIG. 4 of the drawings is a partial cross-sectional view of the elongated vacuum tube within the apical region, and near the apical termination of a canal of a root; and

FIG. 5 of the drawings is a block diagram of the operation of the apparatus.

### DETAILED DESCRIPTION

While this invention is susceptible of embodiment in many different forms, there is shown in the drawings and described herein in detail a specific embodiment with the understanding that the present disclosure is to be considered as an exemplification of the principles of the invention and is not intended to limit the invention to the embodiment illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

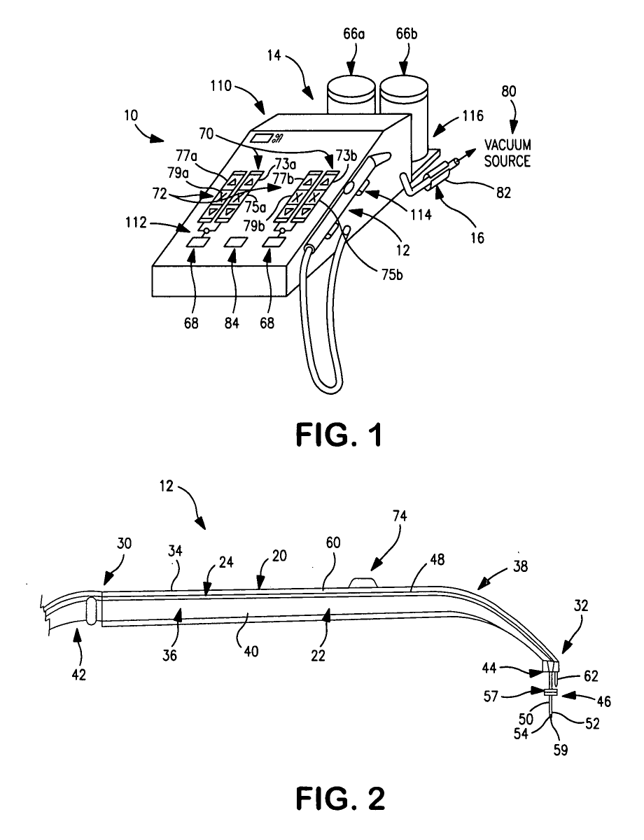

With reference to the Figures, and in particular FIG. 1, Apical irrigation fluid delivery apparatus (hereinafter, the apparatus) is shown generally at 10. The apparatus is typically utilized by dentists to clean the pulp chamber and the canals of a tooth in preparation for or during a root canal procedure. The apparatus includes applicator assembly 12, irrigation fluid supply assembly 14 and vacuum supply assembly 16. The irrigation fluid supply assembly and the vacuum supply assembly are included in a housing 110. Applicator assembly 12 can be releasably coupled to the control center assembly by applicator hook 114 so as to facilitate handling, shipment and mobility of the device within a dental office. Of course, the particular configuration of the apparatus is not limited to that which is shown in FIG. 1, and variations to the overall configuration are contemplated.

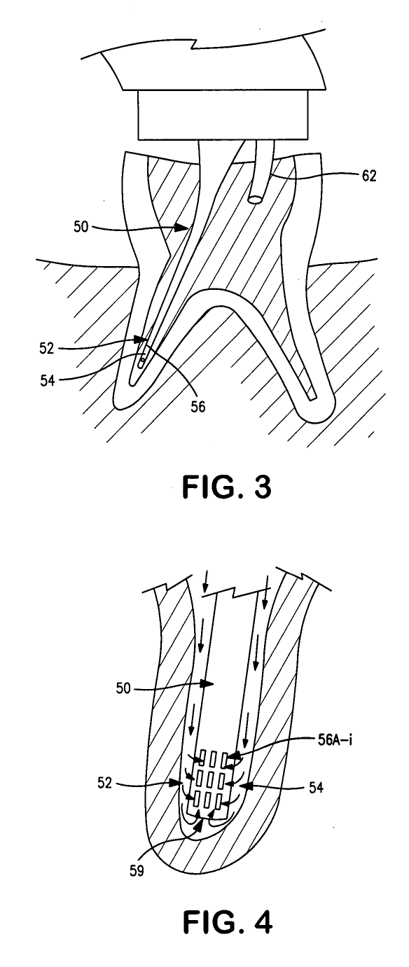

Applicator assembly 12 is shown in FIGS. 2 through 4, collectively as comprising body 20, vacuum applicator assembly 22 and tooth fluid directing assembly 24. Body 20 includes proximal end 30, distal end 32 outer surface 34 and inner cavity 36. The body 20 is generally an elongated tubular member having a neck region 38 positioned at distal end thereof, the neck being angled at an angle of approximately 20° and 50°, most preferably, and at other angles, such as angles between 0° and 90°. Such a configuration aids in the proper positioning of the device within the mouth of a patient, and aids in the minimal intrusiveness of the device within the mouth of a patient.

The body is configured to be held in a single hand by a user, for example, in a manner similar to a pencil or a pen. Of course, variations can be made to the configuration of the outside surface so as to specifically complement the hand of a particular user. The inner cavity 36 extends from the proximal end to the distal end and houses the internal vacuum and fluid delivery conduits. In certain embodiments, it may be desirable to expose these conduits, however, in the embodiment shown, these conduits are hidden from view.

The vacuum applicator assembly 22 includes vacuum conduit 40, source connector 42, overflow vacuum inlet 44 and apical vacuum assembly 46. The vacuum conduit 40 extends from the proximal end 30 to the distal end 32 of the body within inner cavity 36. It will be understood, and will be explained, the vacuum conduit 40 includes a flexible conduit which terminates with source connector 42 that is coupled to the vacuum supply conduit. In certain embodiments, the vacuum supply conduit may comprise a single flexible conduit which extends from the vacuum supply assembly to the distal end of the apical vacuum assembly. In other embodiments, the portion of the vacuum conduit within the inner cavity 36 of the body may comprise a rigid member which, through a coupling is associated with a flexible portion.

The apical vacuum assembly 46 extends from distal end 32 of the body of the applicator assembly. The apical vacuum assembly 46 includes elongated vacuum tube 50 having distal end 52 and inlet region 54. The elongated tube has a diameter which is suitable for insertion within a canal of a tooth, such that the apical region, and preferably the apical termination can be reached. In one embodiment, the diameter of the portion of the elongated vacuum tube which is placed within a tooth canal is approximately 0.32 mm. Of course other dimensions are likewise contemplated. The length of the elongated vacuum tube can range from between 10 mm and 30 mm. In certain embodiments, the elongated vacuum tube may comprise a flexible or rigid polymer member, which is capable of conforming to the shape of the canal. In other embodiments, it is contemplated that the elongated vacuum tube may comprise a rigid metal member which is sized so as to reach the apical region and preferably the apical termination of the tooth without substantially flexing. In still other embodiments, the metal member may have a certain degree of flexibility. Stop 57 may be threaded or frictionally engaged with the elongated vacuum tube. The user can move the stop 57 along the length of the elongated vacuum tube such that the stop 57 can approach the top of the tooth as the elongated vacuum tube 50 approaches the apical termination, so as to guide the dentist and to preclude excessive contact, and in turn, damage to the apical region and the apical termination.

The distal end 52 of the apical vacuum assembly 46 includes an inlet region. In certain embodiments the inlet region 54 may comprise a cylindrical opening at the end of the elongated vacuum tube that substantially matches the cross-sectional configuration of the elongated vacuum tube. In other embodiments, such as the embodiment shown in FIG. 4, the inlet region 54 is caped at termination end 59, and along the outer surface of the tube itself, a plurality of openings, such as openings 56a through 56i are positioned. In the embodiment shown, the openings are substantially rectangular in configuration and comprise a plurality of rows of openings extending away from the termination of the distal end. The openings are sized so as to accept debris collected by the irrigation process without clogging. In the embodiment shown, three rows of openings are contemplated.

The overflow vacuum inlet 44 is shown in FIG. 2 as comprising an opening which is positioned at the distal end of the body of the applicator assembly. The overflow vacuum inlet is sized so that it covers the upper surface of the tooth when the apical vacuum assembly is positioned within the canal of a tooth.

The tooth fluid directing assembly 24 is shown in FIG. 2 as comprising fluid supply conduit 60 and dispensing opening 62. The fluid supply conduit extends from the irrigation fluid supply assembly 14, through body 20 of the applicator assembly 12 and to the distal end thereof. In certain embodiments, the fluid supply conduit 60 comprises a flexible member that extends from the assembly 14 through the body 20. In other embodiments, the conduit can extend along the outer surface 34 of the body 20. In still other embodiments, the conduit may include a flexible portion between assembly 14 and the body 20, wherein the flexible portion is coupled to a rigid conduit which extends within the body 20 of the applicator assembly 12.

Dispensing opening 62 extends from distal end 32 of the body 20 proximate the elongated vacuum tube. The dispensing opening 62 is spaced apart from the distal end 52 of the elongated vacuum tube such that the dispensing outlet dispenses fluid within the pulp chamber or at the upper end of the canal within which the elongated vacuum tube is positioned. In certain embodiments, the dispensing outlet may comprise a diameter which is comparable to that of the elongated vacuum tube, larger or smaller. Indeed, it is necessary to achieve a desired flow rate from the dispensing outlet. In the embodiment shown, the dispensing outlet comprises a metal tubing which is substantially rigid. In other embodiments, a flexibility may be desired. In turn, the materials may be modified so that the dispensing outlet has a certain degree of flexibility.

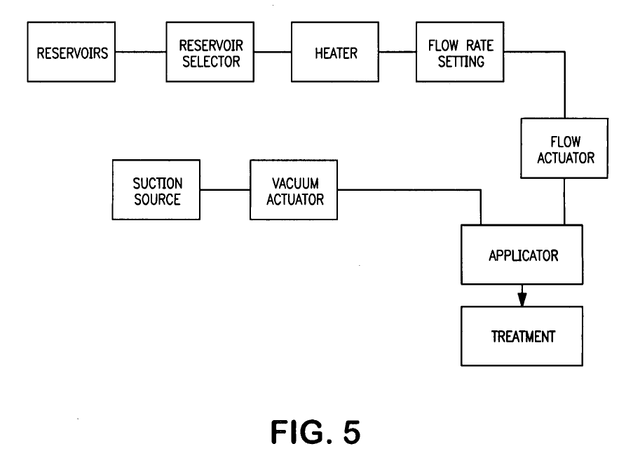

Irrigation fluid supply assembly 14 is shown schematically in FIG. 5 as comprising fluid reservoirs, such as reservoirs 66a, 66b, reservoir selector 68, fluid heater assembly 70, fluid flow rate controller 72 and fluid flow rate actuator 74. These components may be cooperatively housed within housing 110, or coupled thereto. The housing 110 provides a convenient manner in which to transport and store the apparatus of the present invention.

The fluid reservoirs 66a, 66b are connected to the reservoir selector 68 such that the user can select irrigation fluid which is selected from one of the two reservoirs. In the embodiment shown, the reservoirs comprise one liter reservoirs which are configured to facilitate the withdrawal of fluid from therewithin. The reservoirs are positioned within reservoir storage region 116. In certain embodiments, a single reservoir may be provided. In other embodiments, more than two reservoirs may be provided. It is contemplated that the number of reservoirs can be varied within the scope of the present invention.

The reservoir selector comprises a valve which is actuated by a user selected switch or button. In the embodiment shown, the selector comprises a pair of buttons on control panel 112 of housing 110, and the necessary valve configuration is contained within housing 110. The fluid heater assembly 70 includes a heater element, heater control members 73a, 73b and heater temperature display member 75a, 75b. The heater element (not shown) is positioned proximate the conduits of each of the fluids which are provided in reservoirs. In the present embodiment, the heater element comprises a common resistive element, while other types of heaters are contemplated.

The heater control members 73a, 73b comprise a plurality of buttons which can direct the heater element to increase or decrease in intensity. The heater temperature display 75a, 75b comprises a LED display which can display the temperature of the particular irrigation fluid, or the desired temperature of the particular irrigation fluid. In certain embodiments, both the desired and the actual temperature can be shown in the display. Of course, other manners in which to set the desired temperature, including analog or digital buttons, knobs and the like are contemplated. Additionally, while a LED display is shown, LCD, analog, and other display types are contemplated for use.

It is contemplated that each of the irrigation fluids may have separate heater elements, heater control members and heater temperature displays. It is likewise contemplated that a single integrated heater, heater control member and heater temperature display may be utilized, which are used for both fluids, and at any given time, correspond to the selected irrigation fluid. It is further contemplated that a single heated temperature may be provided, or that a heating assembly 70 may be omitted from certain designs.

The fluid flow rate controller 72 comprises a pump (internal to the housing), flow rate control member 77a, 77b and flow rate display 79a, 79b. It will be understood that the fluid reservoirs are placed in selective fluid communication with the tooth fluid directing assembly 24 through fluid flow rate controller 72. The pump can be set to operate at different speeds or capacities, so as to have different flow rates to the dispensing opening of the tooth fluid directing assembly 24. The flow rate control member 77a, 77b includes buttons or actuators which can increase or decrease the rate at which irrigation fluid is dispensed from dispensing opening 62. In the embodiment shown, it is contemplated that the flow rate can be varied between 1 and 15 ml/min. Of course, other flow rates may be contemplated and are within the scope of the present invention.

In the embodiment shown, a separate button is provided to decrease or to increase the flow rate, and the flow rate is increased or decreased in increments by actuating one of the two provided buttons. In other embodiments, a rotary knob, or another commonly utilized control may be provided to vary the flow rate of the fluid. A set of actuators to increase or decrease the flow rate of the irrigation fluid is provided for each of the fluid reservoirs. It is contemplated that a single actuator can be provided, such that it controls the flow rate of the selected fluid.

In other embodiments, the flow rate may be set at a single, non user modifiable, flow rate. Furthermore, programmed flow rates may be provided within the system based upon the fluid that is being utilized.

Flow rate displays 79a, 79b are provided on the control panel 112 of housing 110. The flow rate displays provide an accurate reading as to the flow rate of the particular fluid. Based on the display, the user can actuate the flow rate control member to vary the flow rate of the different fluids from within the reservoirs. In the embodiment shown, separate displays are provided for each of the irrigation fluids, while it is contemplated that a single display may be provided such that it displays the flow rate of the currently utilized irrigation fluid.

Fluid flow actuator 74 is shown in FIG. 2 as comprising an actuator button positioned on outer surface 34 of body 20 of the applicator assembly. It will be explained below that the user presses the actuator button to enable flow of the fluid through the applicator assembly and into the pulp chamber of the tooth. In other embodiments, this may be enabled by a foot pedal or another actuator positioned remote of the body of the applicator assembly.

Vacuum supply assembly 16 is shown in FIG. 1 as comprising vacuum source 80, vacuum intensity control valve 82 and vacuum actuator 84. Typically, dental offices include outside vacuum sources, and the system is configured to couple to these outside vacuum sources. As such, vacuum source 80 may comprise a connector capable of taping into an outside vacuum source. In other embodiments, vacuum source may comprise a self-contained vacuum drawing device (i.e., a venture, or other device) for pulling a vacuum. Vacuum intensity control valve 82 cooperates with vacuum actuator 84 wherein the vacuum actuator 84 toggles the valve 82 to selectively allow or preclude the pulling of a vacuum. The vacuum source 80 is placed thereby, in fluid communication selectively with vacuum conduit 40 (FIG. 2). In the embodiment shown, the vacuum actuator comprises a selector button positioned on control panel 112 of housing 110.

The operation of the device will be described with respect to a typical dental procedure which can be accomplished with the present invention. The particular manner of use is not to be deemed a limiting usage or process, but an exemplification of the principles of the invention. Moreover, it will be understood that while the procedure will be described as being completed by a dentist, the term dentist shall include one or more individuals which may be dentists, endodontists, practitioners, assistants, nurses among others.

Specifically, the dental practitioner first prepares the apparatus for use. Namely, the user first selects fluids with which to fill the reservoirs. A number of different fluids are contemplated for use, including but not limited to, including, but not limited to sodium hypochlorite, chlorhexidine gluconate (optionally with cetrimide, commonly referred to as Cetrexidin), ETDA (Ethylene-diaminetetraacetic acid and framycetin sulfate (Septomixine), citric acid, water, chlorine, among others.

More specifically, the reservoirs are filled with the desired fluids. In one embodiment, it is contemplated that one of the reservoirs is filled with a cleaning solution, such as a solution including chlorine, and, the other reservoir can be filled with an acidic solution such as ETDA or citric acid. The different solutions perform different functions, and it is often necessary to utilize a plurality of different solutions.

Once the solutions have been decided upon and prepared, the dentist then determines the temperature at which the fluids will be utilized and the desired flow rates associated with each of the fluids. These flow rates and temperatures can be set by dentist by interfacing with the control panel. It will be understood that during the procedure, or at any time prior to the procedure, the dentist can adjust the flow rates and the temperatures associated with any one of or all of the fluids contained in the reservoirs.

Once the solutions are prepared, the dentist prepares the tooth of the patient. Specifically, the dentist has cleaned out a portion of the pulp chamber of the patient, and is now ready to clean the canals of the root. To achieve same, the dentist directs the applicator assembly into the mouth of the patient. The elongated vacuum tube is directed into a canal to be treated. As the distal end 52 of the elongated vacuum tube approaches the apical region and toward the apical termination, the dispensing opening 62 approaches or tends into the pulp chamber of the tooth, and the overflow vacuum inlet 44 overlies the tooth (or is in contact therewith).

As the dentist has likely taken x-rays of the tooth of the patient the dentist can determine where to install stop 57 along the elongated vacuum tube 50 so as to reach the proper and desired depth. In other embodiments, the dentist can place a visual marking on the elongated vacuum tube at the proper length. In still further embodiments, a substantially constant diameter elongated vacuum tube can be provided wherein the dentist can cut the tube to the desired length for a particular patient.

Once properly positioned, the dentist can activate the flow of fluid and the vacuum as desired. In particular, once positioned, the dentist can actuate the vacuum through the button provided on the control panel 112 of housing 110. The dentist can also then depress the button located on the body of the applicator assembly to activate the flow of fluid through the dispensing opening.

Significantly, the dispensing opening does not reach to the depth in the canal at which the distal end of the elongated vacuum tube is positioned. Thus, the fluid is drawn by the vacuum pulled in the distal end of the elongated vacuum tube into the apical region and toward the apical termination. At such time it is drawn into the inlet region of the elongated vacuum tube. Thus, the fluid is pulled to and then sucked away from the apical region and apical termination through negative pressure. Advantageously, the fluid does not impact the apical region and the apical termination with such force that it is destructive. Moreover, inasmuch as the inlet region is positioned proximate the apical termination, the irrigation fluid passes through, preferably, the entirety of the root, thereby providing effective cleaning of the entire root canal.

Inasmuch as certain of the fluids, and in particular, the acidic fluids are configured to remove solids from the inner surface of the root canal, the inlet region preferably includes a plurality of openings which are sized so as to receive and withdraw such solids from within the canal. Such a configuration is shown in FIG. 4.

To the extent that the flow of irrigation fluid from the dispensing opening 62 of the tooth fluid directing assembly exceeds that which can be reasonably pulled out by the apical vacuum assembly, as the fluid approaches the pulp chamber and begins to overflow same, the overflow vacuum inlet is in close proximity to the overflow fluid and removes the fluid through vacuum pulling. The overflow vacuum inlet is positioned and sized such that the overflow inlet pulls fluid without substantially affecting the movement of fluid through the apical vacuum assembly.

It will be understood that at any time during the procedure, the dentist may selectively stop and start the flow of fluid and selectively stop and start the vacuum suction. Additionally, the dentist may change the fluid that is passing through the dispensing opening, the temperature of the fluid and the flow rate of the fluid.

Once the dentist believes that the root has been properly cleaned, the dentist can remove the applicator assembly 12 from within the mouth of the patient. After the fluid is turned off, the dentist may retain the vacuum for a period of time to insure that the fluid has been removed from within the pulp chamber and the canal. Other canals may then be cleaned under the same procedure, to the extent that such canals exist. Finally, the dentist may fill the pulp chamber and complete the root canal procedure.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. An apical irrigation fluid delivery apparatus comprising:
an applicator assembly having:
a body having an outer surface, a proximal end and a distal end opposite the proximal end;
a vacuum applicator assembly including a vacuum conduit and an apical vacuum assembly comprising an elongated vacuum tube in fluid communication with the vacuum conduit and a distal end having an inlet region, the distal end spaced apart from the distal end of the body, the elongated vacuum tube structurally configured for insertion into an apical region of a canal of a patient; and
a tooth fluid directing assembly comprising a fluid supply conduit and a dispensing opening, the dispensing opening extending away from the applicator assembly proximate the apical vacuum assembly and terminating prior to the distal end of the elongated vacuum tube;
a vacuum supply assembly including a vacuum source in communication with the vacuum conduit of the vacuum applicator assembly and a vacuum actuator coupled to the vacuum source which selectively places the vacuum source in communication with the elongated vacuum tube;
an irrigation fluid supply assembly including a reservoir and a fluid flow rate controller including a pump, the pump coupled to the reservoir and to the fluid supply conduit, and a fluid flow actuator coupled to the fluid flow rate controller which selectively directs fluid from the reservoir to the fluid supply conduit.

2. The apical irrigation fluid delivery apparatus of claim 1 further comprising an overflow vacuum inlet extending away from the distal end of the body such that the dispensing opening of the tooth directing assembly is positioned between the overflow vacuum inlet and the distal end of the elongated vacuum tube of the apical vacuum assembly.

3. The apical irrigation fluid delivery apparatus of claim 2 wherein the overflow vacuum inlet includes a cross-sectional area which is larger than a cross-sectional area of the inlet region of the elongated vacuum tube and larger than a cross-sectional area of the dispensing opening of the tooth fluid directing assembly.

4. The apical irrigation fluid delivery apparatus of claim 1 further comprising a neck region proximate the distal end, the neck region angled relative to the body at an angle of approximately 20° and 50°.

5. The apical irrigation fluid delivery apparatus of claim 1 wherein the applicator assembly is configured for handling with a single hand of a dentist.

6. The apical irrigation fluid delivery apparatus of claim 1 wherein the distal end of the elongated vacuum tube terminates at a termination end, the inlet region further comprises a plurality of openings spaced away from the termination end.

7. The apical irrigation fluid delivery apparatus of claim 6 wherein the plurality of openings comprises a plurality of rows of openings each sequentially spaced apart from the termination end of the distal end of the elongated vacuum tube.

8. The apical irrigation fluid delivery apparatus of claim 1 wherein the irrigation fluid supply conduit further comprises a heater assembly including a heater element associated with one of the fluid flow rate controller and the fluid supply conduit, and a heater control member coupled to the heater assembly for controlling the intensity of the heater element.

9. The apical irrigation fluid delivery apparatus of claim 8 wherein the heater assembly further includes a heater temperature display associated with the heater control member, and the heater control member includes at least one button for altering the intensity of the heater element.

10. The apical irrigation fluid delivery apparatus of claim 1 further comprising a plurality of fluid reservoirs and a reservoir selector for selecting the desired reservoir for placement in fluid communication with the fluid supply conduit of the fluid directing assembly.

11. The apical irrigation fluid delivery apparatus of claim 1 wherein the fluid flow rate controller further includes a flow rate control member having a range of adjustable flow rates and a flow rate display, the flow rate display structurally configured to display a current flow rate within the range of adjustable flow rates.

12. The apical irrigation fluid delivery apparatus of claim 1 wherein the irrigation fluid supply assembly and the vacuum supply assembly are positioned within a housing, the housing including a control panel, an applicator hook and a reservoir storage region.

13. The apical irrigation fluid delivery apparatus of claim 12 wherein the control panel further includes the vacuum selector, a fluid flow rate controller and a fluid temperature selector.

14. The apical irrigation fluid delivery apparatus of claim 12 wherein the reservoir storage region includes a plurality of reservoirs positioned thereon.

15. The apical irrigation fluid delivery apparatus of claim 1 wherein the vacuum conduit includes a constant radius region along a portion of the length thereof extending to the distal end, wherein the vacuum conduit is configured for severing to a desired length.
